(19) United States
(12) Patent Application Publication
(10) Pub. No.: US 2006/0068763 A1
(43) Pub. Date: Mar. 30, 2006

(54) Polyrhythm generator for mobile audio platform applications and methods thereof

(75) Inventors: Adam Che-Ya Chang, Hsinchu (TW); Chieh-I Huang, Hsinchu (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Macronix International Co., Ltd.

(21) Appl. No.: 11/227,622

(22) Filed: Sep. 15, 2005

Related U.S. Application Data
(60) Provisional application No. 60/614,058, filed on Sep. 30, 2004.

(51) Int. Cl. H04L 12/58

(52) U.S. Cl. 455/412.1; 455/550.1; 455/567

(57) ABSTRACT

A mobile communications device includes a host processor, a host interface coupled to the host processor, a polyrhythm generator coupled to the host processor for processing a first signal and transferring the processed first signal to the host processor via the host interface, and an input device coupled to the polyrhythm generator for providing the first signal for processing. The polyrhythm generator includes a firmware for multi-platform applications capable of transforming a single-tone to a multi-tone melody.

### CROSS-REFERENCE TO RELATED APPLICATIONS

This application claims benefit of U.S. Provisional Application No. 60/614,058 filed Sep. 30, 2004, which is herein incorporated by reference in its entirety.

### BACKGROUND OF THE INVENTION

1. Field of the Invention

The present invention relates generally to a mobile telephone and, more particularly, to a system architecture for allowing a single-tone to be generated as a polyrhythmic melody in a mobile communications setting.

2. Background Art

Cellular, or mobile, phones today are capable of performing a wide variety of tasks due to improvements in the semiconductor technology. Cellular phones, for example, not only can be used to place calls, but also may be used to access the Internet, send and receive email and text messages, and act as a personal digital assistant (or PDA). More fundamentally, cellular phones can be used to call almost anywhere around the world.

However, due to the increasing popularity, manufacturers are adding functionalities to a cellular phone. Specifically with regard to audio/speech capabilities, conventional cellular phones require different system architecture setups to perform different functionalities due to different requirements for signal processing.

### BRIEF SUMMARY OF THE INVENTION

In accordance with the present invention, there is provided a mobile communications device that includes a host processor, a host interface coupled to the host processor, and a polyrhythm generator coupled to the host processor for processing a first signal and transferring the processed first signal to the host processor via the host interface. The polyrhythm generator includes a firmware for multi-platform applications capable of transforming a single-tone to a multi-tone melody.

Also in accordance with the present invention, there is provided a cellular phone that includes a host processor for providing a digital signal, a polyrhythm generator coupled to the host processor for receiving and processing single-tone data and providing multi-tone data, and an output device for receiving and outputting the multi-tone data as analog signal, wherein the polyrhythm generator is capable of performing a plurality of audio signal processing functionalities.

Additionally in accordance with the present invention, there is provided a method of signal processing in a mobile communications device that includes providing a host processor, providing a host interface coupled to the host processor, providing a polyrhythm generator coupled to the host processor, processing a first signal and transferring the processed first signal to the host processor via the host interface, and providing the first signal to the polyrhythm generator for processing, wherein the polyrhythm generator includes a firmware for multi-platform applications capable of transforming a single-tone to a melody.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the present invention and together with the description, serves to explain the principles of the invention.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a block diagram of a cellular system architecture consistent with one embodiment of the present invention;

FIG. 2 is an exemplary block diagram of the mobile audio platform device;

FIG. 3 is a block diagram consistent with one embodiment of the mobile audio platform device;

FIG. 4 is a flow diagram of a method consistent with one embodiment of the present invention; and

FIG. 5 is a block diagram consistent with one embodiment of the present invention.

### DETAILED DESCRIPTION OF THE INVENTION

In this detailed description, for purposes of explanation, numerous specific details are set forth to provide a thorough understanding of embodiments of the present invention. One skilled in the art will appreciate, however, that embodiments of the present invention may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of embodiments of the present invention.

Embodiments of the present invention relate to apparatuses and methods for a mobile audio platform (“MAP”) architecture operable between a baseband processor and either an output device or an input device. The architecture and method of MAP of the present invention may be preferably implemented in a mobile communications device that either receives or outputs analog signals, such as a cellular telephone or any mobile communications device with an integrated cellular phone. Consistent with the present invention, a single MAP architecture provides multi-platform applications that provide enhanced audio/speech signal processing.

Embodiments of systems and methods related to a mobile audio MAP architecture are described in this detailed description of the invention, which includes the accompanying drawings. In this detailed description, for purposes of explanation, numerous specific details are set forth to provide a thorough understanding of embodiments of the present invention. One skilled in the art will appreciate, however, that embodiments of the present invention may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of embodiments of the present invention.

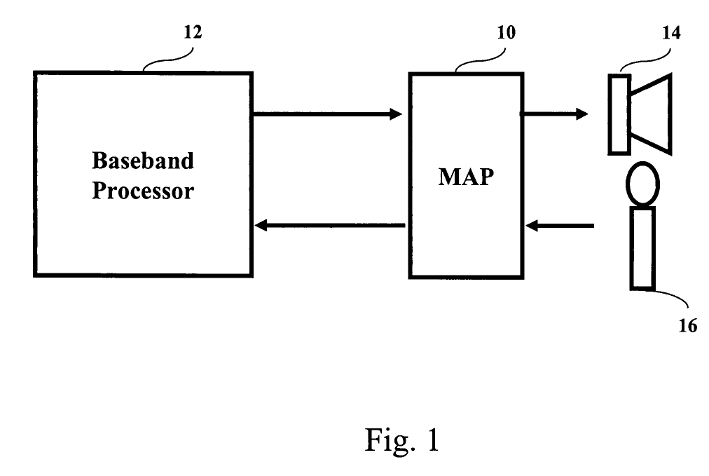

FIG. 1 is a block diagram of the general architecture consistent with one embodiment of the MAP of the present invention. Referring to FIG. 1, a MAP 10 is coupled to a baseband processor 12, an output device 14, and an input device 16. Examples of output device 14 include speakers, headphones, and analog baseband devices. Examples of input device 16 include microphones, FM receivers, and baseband devices capable of producing an analog signal. In the cellular communications context, baseband processor 12 may be implemented in a baseband chipset with an ARM® RISC processor and is also referred to herein as a host processor. A host processor is primarily responsible for protocol processing and user interface. The functions of a host processor and MAP 10 include the ability to access system memories, such as flash memories, random access memories (RAMs), read-only memories (ROMs), and static random access memories (SRAMs), control peripheral components such as LCD and other visual displays and indicators, and process signals received from a peripheral component such as a keypad. MAP 10 may also be referred to herein as a target processor. A telecommunications device of the present invention may incorporate a plurality of MAPs to afford the device different functionalities, coupled with different firmware, to be provided by the MAPs.

In its most rudimentary form, MAP 10 is a co-processor directed to audio or speech applications and may be disposed between a baseband chipset and electro-acoustic components in a telecommunications device. Through firmware, a MAP is able to transform a single-tone into a melody. In one embodiment, MAP 10 is a digital signal processor (DSP) capable of physical layer processing, and may include speech or audio coder/decoders (CODECs). MAP 10 may be implemented as a separate integrated circuit from baseband processor 12 or integrated with baseband processor 12. The functions of MAP 10 are controlled by different algorithms, or firmware. The firmware is adapted for multi-platform applications, such as speech compression and decompression, audio decoding, and signal processing. Such algorithms and firmware can be implemented by MAP 10 to convert one type of tone so that a certain melody can be outputted. In one embodiment, the algorithms or firmware is stored in system memories described above.

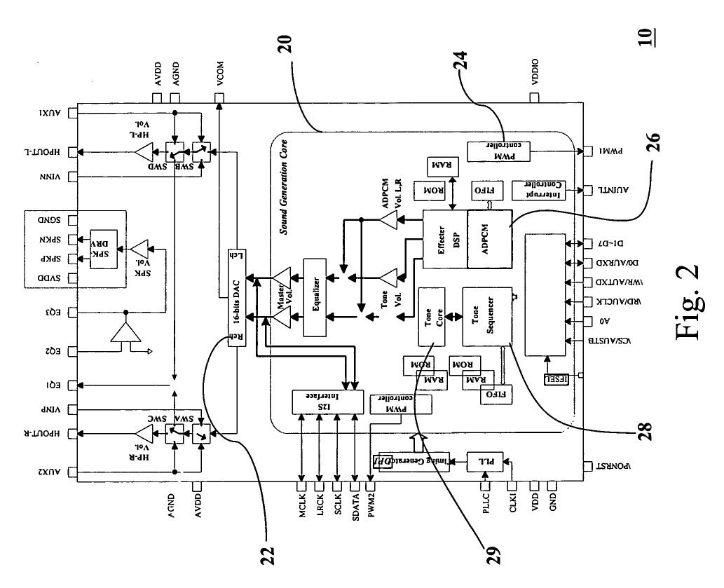

FIG. 2 is a block diagram of an embodiment of MAP 10 of FIG. 1. Referring to FIG. 2, MAP 10 includes a 16-bit DAC 22 and a sound generation core 20. Sound generation core 20 includes a parametric equalizer that is fully firmware controlled capable of tuning for speaker characteristics in system implementation. Sound generation core 20 also includes a pulse width modulation (PWM) controller 24 for vibration and light emitting diode (LED) control. PWM controller 24 may be controlled by incoming contents and/or threshold settings. For example, vibration control settings may be downloaded into the firmware for MAP 10 that controls the type of vibration provided by PWM controller 24. MAP 10 also includes a plurality of interfaces for receiving input signals from input devices and providing output signals to output devices and/or other components.

Sound generation core 20 additionally includes an Adaptive Differential Pulse Code Modulation (ADPCM) CODEC 26 for digital speech compression. In addition to processing speech signals, ADPCM CODEC 26 is also capable of processing music and sound effects. Sound generation core 20 further includes a hardware sequencer in the form of a tone sequencer 28 coupled to a tone core 29.

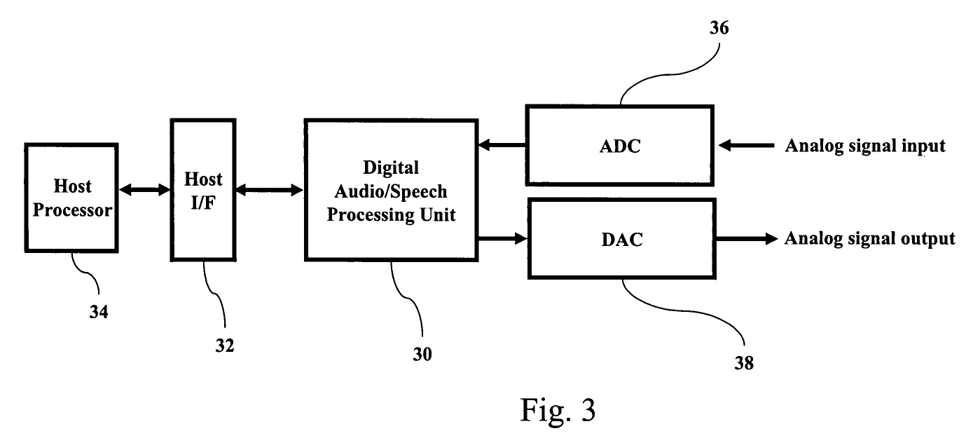

FIG. 3 is a more detailed block diagram of FIG. 1. Referring to FIG. 3, a digital audio/speech processing unit 30 is one embodiment of the MAP of the present invention. Digital audio/speech processing unit 30 is coupled to a host interface 32, which in turn is coupled to a host processor 34. Host interface 32 may be integrated with host processor 34. Digital audio/speech processing unit 30 is also coupled to an ADC (analog-to-digital converter) 36 and a DAC (digital-to-analog converter) 38. In one embodiment, ADC 36 and DAC 38 are integrated with digital audio/speech processing unit 30. ADC 36 receives analog signals and outputs digital signals whereas DAC 38 receives digital signals and outputs analog signals.

In operation, ADC 36 receives an input analog signal and converts it to a digital signal. The digital signal is provided to audio/speech processing unit 30, which manipulates the digital signal as specified by a particular MAP operation. Audio/speech processing unit 30 then either transfers the processed digital data to host processor 34 via host I/F 32, or converts the processed digital data to analog signal via DAC 38 and delivers it to an analog input port of other processors, or output devices such as speakers and headphones.

More generally, programs (or firmware) of the MAP processor is stored in an on-board, or system, memory controlled by the host processor. When needed, the programs may be downloaded to a program memory of the MAP. The size of the program memory may be of different sizes. In one embodiment, system program memories may be non-volatile memories such as flash memories or EEPROMs. The architecture allows the MAP to provide a number of functions and features with limited program space. Furthermore, this architecture allows for the various programs (firmware) for the MAP to be upgraded as needed.

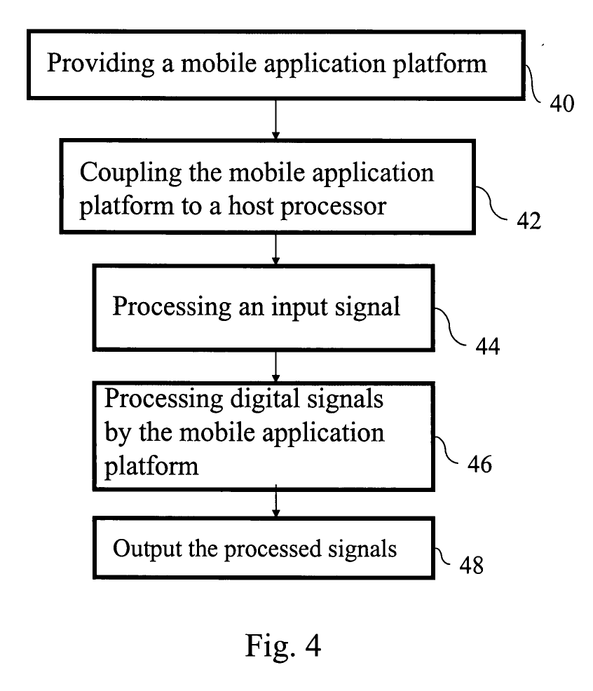

The present invention also provide as method of signal processing in a mobile communications device. FIG. 4 is a flow diagram of one method of the present invention. Referring to FIG. 4, the method includes the steps of providing a host processor and providing a host interface coupled to the host processor (not shown). The method also includes providing a mobile audio platform unit 40 and coupling the mobile audio platform unit to the host processor 42. Firmware for the mobile audio platform unit is also provided (not shown). Input signals are then processed 44, such as analog to digital conversion, and the processed signals are transferred to the host processor via the host interface. At step 46, Digital signals are provided to the mobile audio platform unit for signal processing as specified by the firmware. The processed signals are output through any one of the output devices discussed above at step 48.

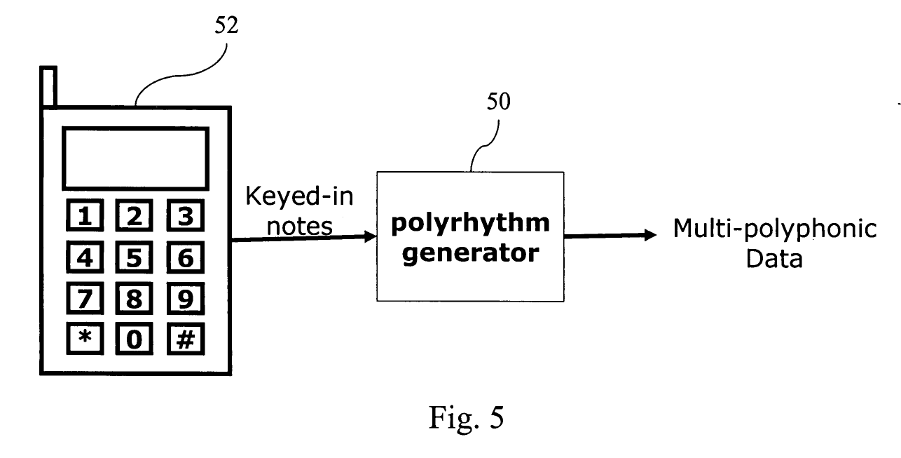

An embodiment of the present invention provides for a conversion of a single-tone data, such as MIDI data, to multi-polyphonic data in the absence of any human intervention. FIG. 5 is a representation of a polyrhythm generator consistent with the present invention. Referring to FIG. 5, a polyrhythm generator 50 is coupled to a telephone keypad 52. Keypad 52 provides a single-tone data to polyrhythm generator 50, which is an embodiment of the MAP of the present invention. Polyrhythm generator 50, through firmware-controlled operations, then processes the single-tone data and outputs a multi-polyphonic data, such as a multi-polyphonic ring tone for a cellular phone.

In application, a user of the cellular phone is able to enter multiple single-tones from the keypad and the polyrhythm generator will in turn generate multiple polyphonic tones. The polyrhythm generator then outputs the tones through the loud speaker of the phone in the form of polyphonic or euphonic tones. In other words, a single-tone data is processed and output by the polyrhythm generator as multi-polyphonic tones. In implementation and referring to FIG. 2, tone sequencer 28 and tone core 29 may be used, in conjunction with firmware, for the generation of polyrhythm. The MAP may also include a MIDI core with a 32-bit, 64-bit (or higher) polyphony, together with ADPCM CODEC 26 to perform the functions of the present invention.

In accordance with an embodiment of the present invention, instructions adapted to be executed by a processor to perform a method are stored on a computer-readable medium. The computer-readable medium can be a device that stores digital information. For example, a computer-readable medium includes a read-only memory (e.g., a Compact Disc-ROM (“CD-ROM”) as is known in the art for storing software. The computer-readable medium can be accessed by a processor suitable for executing instructions adapted to be executed. The terms “instructions configured to be executed” and “instructions to be executed”) are meant to encompass any instructions that are ready to be executed in their present form (e.g., machine code) by a processor, or require further manipulation (e.g., compilation, decryption, or provided with an access code, etc.) to be ready to be executed by a processor.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A mobile communications device, comprising:
a host processor;
a host interface coupled to the host processor; and
a polyrhythm generator coupled to the host processor for processing a first signal and transferring the processed first signal to the host processor via the host interface,
wherein the polyrhythm generator includes a firmware for multi-platform applications capable of transforming a single-tone to a multi-tone melody.

2. The mobile communications device of claim 1, wherein the polyrhythm generator comprises speech or audio coder/decoders.

3. The mobile communications device of claim 1, further comprising an input device coupled to the polyrhythm generator for providing the first signal for processing,

4. The mobile communications device of claims 1, wherein the polyrhythm generator is integrated with the host processor on a single integrated circuit.

5. The mobile communications device of claim 1, further comprising an output device, coupled to the polyrhythm generator, for receiving and outputting a second signal.

6. The mobile communications device of claim 5, wherein the second signal is an analog signal.

7. The mobile communications device of claim 1, wherein the input device comprises a microphone, FM receiver, or a baseband device.

8. The mobile communications device of claim 5, wherein the output device comprises a speaker, headphone, or an analog baseband device.

9. The mobile communications device of claim 1, further comprising an analog-to-digital converter coupled to the input device, and a digital-to-analog converter.

10. The mobile communication device of claim 1, wherein the polyrhythm generator comprises a tone sequencer and a tone core coupled to the tone sequencer.

11. A cellular phone, comprising:
a host processor for providing a digital signal;
a polyrhythm generator coupled to the host processor for receiving and processing single-tone data and providing multi-tone data; and
an output device for receiving and outputting the multi-tone data as analog signal,
wherein the polyrhythm generator is capable of performing a plurality of audio signal processing functionalities.

12. The cellular phone of claim 11 wherein the multi-tone data comprise MIDI data.

13. The cellular phone of claim 11, wherein the polyrhythm generator comprises speech or audio coder/decoders.

14. The cellular phone of claim 11, wherein the polyrhythm generator is integrated with the host processor on a single integrated circuit.

15. The mobile communications device of claim 11, further comprising an analog-to-digital converter coupled to the input device, and a digital-to-analog converter.

16. The mobile communications device of claim 11, wherein the polyrhythm generator comprises a tone sequencer and a tone core coupled to the tone sequencer.

17. A method of signal processing in a mobile communications device, comprising:
providing a host processor;
providing a host interface coupled to the host processor;
providing a polyrhythm generator coupled to the host processor;
processing a first signal and transferring the processed first signal to the host processor via the host interface; and
providing the first signal to the polyrhythm generator for processing,
wherein the polyrhythm generator includes a firmware for multi-platform applications capable of transforming a single-tone to a melody.

18. The method of claim 17 wherein the polyrhythm generator providing a digital signal processor capable of physical layer processing.

19. The method of claim 17, further comprising providing speech and baseband coder/decoders in the polyrhythm generator.

20. The method of claim 17, further comprising providing an analog-to-digital converter, coupling the analog-to-digital converter to the input device, and providing a digital-to-analog converter.
